(19) United States
(12) Patent Application Publication
(10) Pub. No.: US 2007/0202794 A1
(43) Pub. Date: Aug. 30, 2007

(54) Air driven register

(76) Inventor: Robert M. Antill, Houston, TX (US)

Correspondence Address: ARNOLD & FERRERA, L.L.P., 2401 FOUNTAIN VIEW DRIVE, SUITE 630, HOUSTON, TX, 77057, US

(21) Appl. No.: 11/363,306

(22) Filed: Feb. 27, 2006

(51) Int. Cl. B60H 1/34

(52) U.S. Cl. 454/153

(57) ABSTRACT

An air distribution device having an air propelled turbine, a first pinion gear axially connected to the turbine, a first external spur gear, a second pinion gear axially connected to the first external spur gear, a second external spur gear in mesh connection with the second pinion gear, a first end of a reciprocating lever in eccentric connection to the second external spur gear, and a second end of the reciprocating lever in connection with a plurality of louvers, the louvers in gang connection. Alternatively, the air distribution device further includes a baffle for directing airflow to an air-propelled turbine. Alternatively, the air distribution device further includes a second plurality of louvers positioned perpendicular to the first plurality of louvers.

### FIELD OF THE INVENTION

The present invention relates generally to air-driven means for varying the direction of the stream of air from a duct outlet of a forced air heating, cooling, or ventilation system. More particularly, the present invention is directed towards a simplified means for transferring energy from the stream of air to oscillate register slats back and forth.

### BACKGROUND OF THE INVENTION

U.S. Pat. No. 2,196,308 to Johnson teaches an air-propelled fan powering a relatively small friction wheel, which, in turn, frictionally engages a relatively larger friction wheel, connected to an eccentric crank that oscillates air-distributing louvers. The weight of the fan wheel assembly gravitationally holds the two friction wheels frictionally engaged.

U.S. Pat. No. 3,242,846 to Bunn teaches an air-propelled means to rotate angularly positioned elliptical discs to effect air distribution. The discs require a depth approximately equal to the largest diameter of the discs, which is approximately equal to the width of the air register opening.

U.S. Pat. No. 2,800,851 to Kronrad, et al. teaches an air-propelled fan powering a gearbox, which turns a crank linked to vanes, thereby effecting air distribution. The illustrated gearbox requires substantial volume within the ventilator enclosure and obstructs airflow.

These teachings also share a limitation in that their physical dimensional requirements generally are not compatible with the dimensions or space available in a modern air register.

### SUMMARY OF THE INVENTION

An air distribution device is provided, wherein the air distribution device includes an air propelled turbine; a first pinion gear axially connected to the turbine; a first external spur gear in mesh connection to the first pinion gear; a second pinion gear axially connected to the first external spur gear; a second external spur gear disposed in mesh connection with the second pinion gear; a first end of a reciprocating lever disposed in eccentric connection to the second external spur gear; and a second end of the reciprocating lever disposed in connection with a first plurality of louvers, the louvers being disposed in gang connection.

Also provided is an air distribution device wherein the device includes an air propelled turbine; a power transfer means disposed in rotational connection to the air propelled turbine so that the speed from the turbine is reduced, thereby providing an output having a lower speed and increased torque; a first end of a reciprocating linking means disposed in eccentric connection with the output of the power transfer means; and a second end of the reciprocating linking means disposed in connection with a plurality of louvers, the louvers being disposed in gang connection.

Further provided is an air distribution device wherein the device includes an air propelled turbine; a first pinion gear axially connected to the turbine; a first external spur gear in mesh connection with the first pinion gear; the first external spur gear further having at least one opening at least partially within the dedendum circle of the first external spur gear, thereby allowing air to pass through the first external spur gear relatively unobstructed; a second pinion gear axially connected to the first external spur gear; a second external spur gear in disposed mesh connection with the second pinion gear, the second external spur gear further having at least one opening at least partially within the dedendum circle of the second external spur gear, thereby allowing air to pass through the second external spur gear relatively unobstructed; a first end of a reciprocating lever disposed in eccentric connection to the second external spur gear, and a second end of the reciprocating lever disposed in connection with a plurality of louvers, the louvers in gang connection.

Further provided is an air distribution device wherein the device further has a second plurality of louvers, the second plurality of louvers being disposed approximately perpendicular to the first plurality of louvers.

Further provided is an air distribution device further having a baffle means positioned to guide airflow through the air propelled turbine.

Further provided is an air distribution device having a second air propelled turbine.

### BRIEF DESCRIPTION OF THE DRAWINGS

FIG. 1 shows a three-dimensional perspective view illustrating the back of an air driven register constructed in accordance with the present invention.

FIG. 2 shows a schematic side view illustrating the air driven register.

FIG. 3 shows a back view with some components cut away, illustrating the air driven register constructed in accordance with the present invention.

FIG. 4 shows a three-dimensional exploded view illustrating connection of components of the air driven register.

FIG. 5 shows a back view, illustrating placement of first louver slats 10 and second louver slats 16 positioned relative to frame 12 of the air driven register constructed in accordance with the present invention.

FIG. 6 shows a side view illustrating an asymmetric positioning of second louver slats 16 and a resulting airflow diversion.

FIG. 7 shows a side view illustrating a symmetric positioning of second louver slats 16 and a resulting airflow diversion.

### REFERENCE NUMERALS IN THE DRAWINGS

The following elements are numbered as described in the drawings and detailed description of the invention:
1, 1′ turbine
2, 2′ turbine shaft
3, 3′ first pinion gear
4, 4′ first external spur gear
5 spur gear shaft
6 second pinion gear
7 second external spur gear
8 lever
9 gang bar
10 first louver slats
11 baffle
12 frame
13 second external spur gear shaft
14 faceplate
15 vent housing
16 second louver slats
17 first louver pivots
18 second louver pivots

### DETAILED DESCRIPTION OF THE DRAWINGS

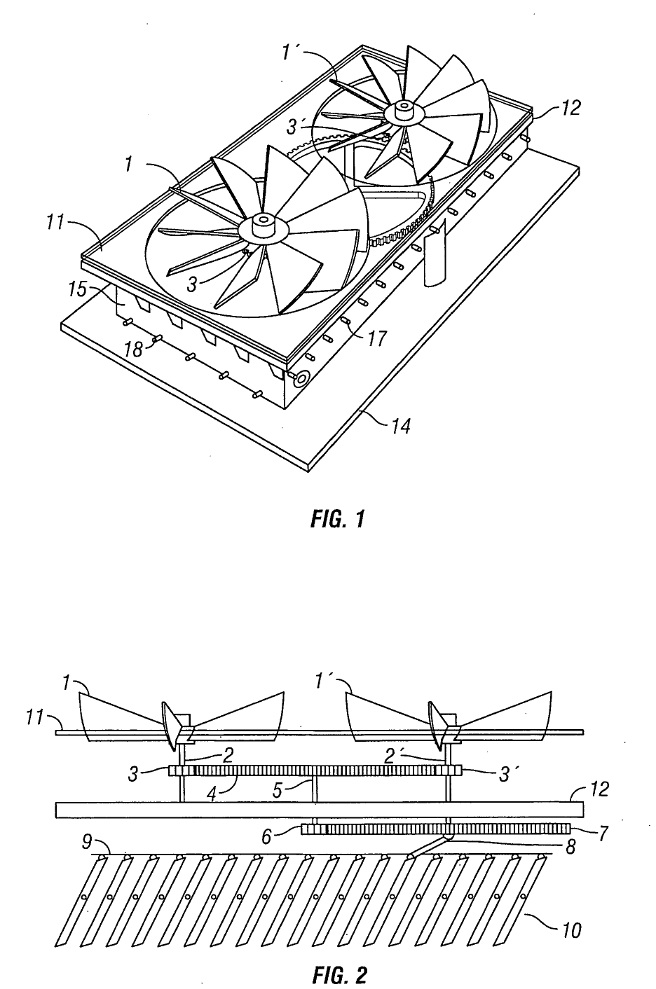

As illustrated in FIG. 1, an air driven register is provided, comprising one or more turbines 1, 1′ axially connected to a first pinion gear 3, 3′, by means of a turbine shaft 2, 2′ (illustrated in FIG. 2). Turbine 1, 1′ may be any of various machines in which the kinetic energy of a moving fluid, such as air, is converted into mechanical power by the impulse or reaction of the fluid with a series of buckets, paddles, blades, or an equivalent structure arrayed about the circumference of a wheel, cylinder, or shaft.

In an alternate embodiment, turbine shaft 2, 2′ is formed structurally integral with turbine 1, 1′. In a further alternate embodiment, first pinion gear 3, 3′ is formed structurally integral with turbine 1, 1′.

In a still further embodiment, fluid flow or airflow is concentrated and/or directed towards turbine 1, 1′ by means of a baffle 11.

In a presently preferred embodiment, turbine 1, 1′ and turbine shaft 2, 2′ and first pinion gear 3, 3′ are supported in place by axial connection of turbine shaft 2, 2′ to frame 12. Frame 12 rests upon and is secured to vent housing 15. Vent housing 15 encompasses a volume beneath frame 12, providing walls to support first louver pivots 17 and second louver pivots 18. A faceplate 14 is attached beneath vent housing 15, serving as the exit orifice for fluids or air flowing past turbine 1, 1′ and through vent housing 15.

FIG. 2 illustrates a schematic side view of the air driven register mechanism. In the depicted embodiment, turbine 1, 1′ is axially connected to turbine shaft 2, 2′. First pinion gear 3, 3′ is axially connected to turbine shaft 2, 2′, preferably beneath turbine 1, 1′. Baffle 11 is located in the vicinity of turbine 1, 1′ preferably above first pinion gear 3, 3′. First external spur gear 4 is positioned such that the gear teeth of first pinion gear 3, 3′ engage the gear teeth of first external spur gear 4.

In an alternate embodiment, the mesh between the gear teeth of first pinion gear 3, 3′ and first external spur gear 4 may be designed to allow for more than one first pinion gear 3, 3′ to simultaneously engage first external spur gear 4.

In one embodiment, first external spur gear 4 is axially connected to one end of spur gear shaft 5, which, in turn, passes through frame 12. Frame 12 is preferably disposed beneath first external spur gear 4. Second pinion gear 6 is connected to the opposite end of spur gear shaft 5, preferably beneath frame 12. Second pinion gear 6 is positioned such that the gear teeth of a second external spur gear 7 engage the gear teeth of second pinion gear 6.

In another embodiment, a first end of a lever 8 is connected to a planar side of second external spur gear 7 at a point distended from the center of second external spur gear 7. A second end of lever 8 is connected to first louver slats 10. In some embodiments, first louver pivots 17 (illustrated in FIG. 1) protrude from the ends of first louver slats 10, thereby enabling pivotal connection to vent housing 15 (also illustrated in FIG. 1). Lever 8 may be any of various linking means suitable for coupling second external spur gear 7 to first louver slats 10, which transfers rotational force from external spur gear 7 so as to move first louver slats 10 in an oscillating fashion. In other embodiments, a plurality of first louver slats 10 is arranged across the airflow area beneath frame 12 such that rotation of the first louver slats 10 about a pivot tends to laterally divert airflow. In still other embodiments, gang bar 9 couples the plurality of first louver slats 10 together such that movement of one first louver slat 10 about a pivot point moves the plurality of first louver slats in unison.

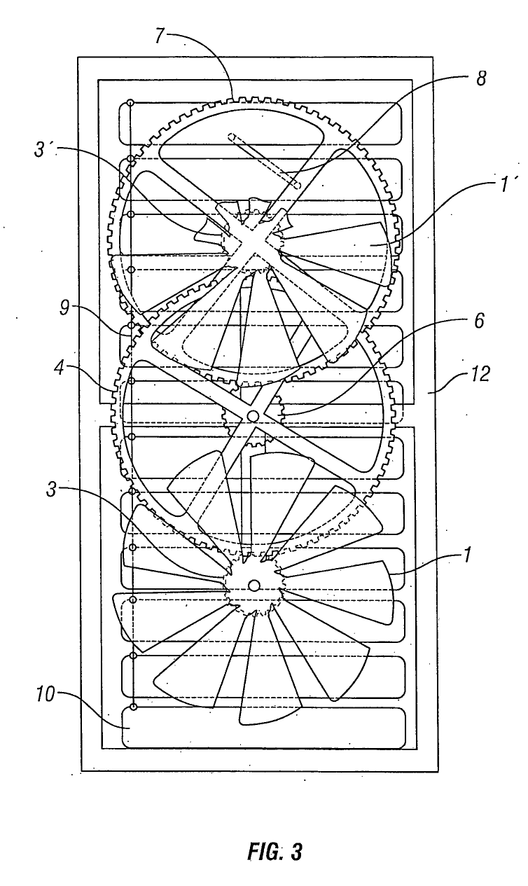

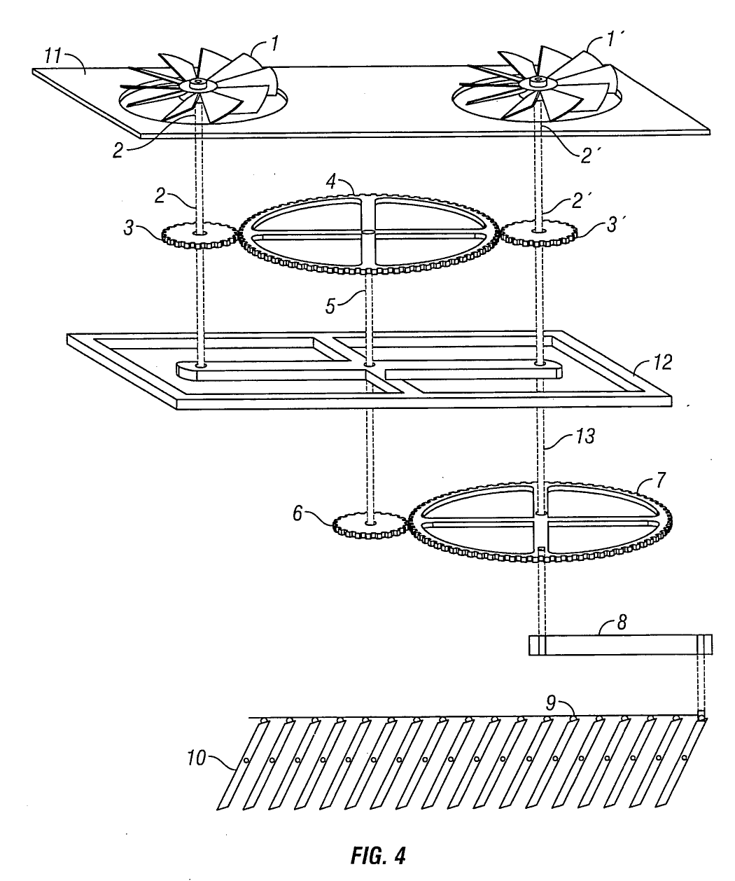

In the example embodiment of FIG. 3, a back view is depicted wherein at least some of the components have been cut away. For example, turbine 1′ is partially cut away to reveal the upper planar side of second external spur gear 7, which is approximately axially located beneath turbine 1′ and first pinion gear 3′.

In other embodiments, second external spur gear 7 is constructed so that a fluid (such as air) is relatively free to flow axially through second external spur gear 7. This is accomplished by minimizing the structural area within the dedendum circle of second external spur gear 7, thereby providing one or more openings between the center and the dedendum circle. In such embodiments, a first end of lever 8 is connected to the under planar side of second external spur gear 7 at a point distended from the center of second external spur gear 7, and second end of lever 8 is connected to one of a plurality of first louver slats 10. Finally, gang bar 9 couples the plurality of first louver slats 10 together.

In a presently preferred embodiment, the distance from the axial center of first pinion gear 3, 3′ to the axial center of second pinion gear 6 has a ratio to the maximal distance from the dedendum circle of the upper planar side of first external spur gear 4 to the dedendum circle of the under planar side of second external spur gear 7 of between approximately 1:2 and approximately 1:4.

FIG. 4 shows a three-dimensional exploded view illustrating exemplary connections between and amongst various components of the air driven register. For example, turbine 1, 1′ is depicted as being axially connected to turbine shaft 2, 2′. First pinion gear 3, 3′ is axially connected to turbine shaft 2, 2′, preferably beneath turbine 1, 1′. Baffle 11 is located in the vicinity of turbine 1, 1′ preferably above first pinion gear 3, 3′. First external spur gear 4 is positioned such that the gear teeth of first pinion gear 3, 3′ engage the gear teeth of first external spur gear 4. The mesh between the gear teeth of first pinion gear 3, 3′ and first external spur gear 4 may be designed to allow for more than one first pinion gear 3, 3′ to simultaneously engage first external spur gear 4.

First external spur gear 4 is preferably constructed such that air is relatively free to flow axially through first external spur gear 4. This is accomplished by minimizing the structural area within the dedendum circle of first external spur gear 4, thereby providing one or more openings through the planar sides between the center and the dedendum circle.

Continuing, first external spur gear 4 is axially connected to one end of spur gear shaft 5, which, in turn, passes through frame 12. Frame 12 is preferably disposed beneath first external spur gear 4. Second pinion gear 6 is connected to the opposite end of spur gear shaft 5, preferably beneath frame 12. Second pinion gear 6 is positioned such that the gear teeth of second external spur gear 7 engage the gear teeth of second pinion gear 6. Second external spur gear 7 is axially connected to, and rotates about, second external spur gear shaft 13. Second external spur gear shaft 13 is coupled to frame 12. A first end of a lever 8 is connected to a planar side of second external spur gear 7 at a point distended from the center of second external spur gear 7. A second end of lever 8 is connected to first louver slats 10. Lever 8 may be any of various linking means to couple second external spur gear 7 to first louver slats 10, transferring rotational force from external spur gear 7 to move first louver slats 10 in an oscillating fashion. Gang bar 9 couples a plurality of first louver slats 10 together such that movement of one first louver slat 10 about a pivot point moves the plurality of first louver slats in unison.

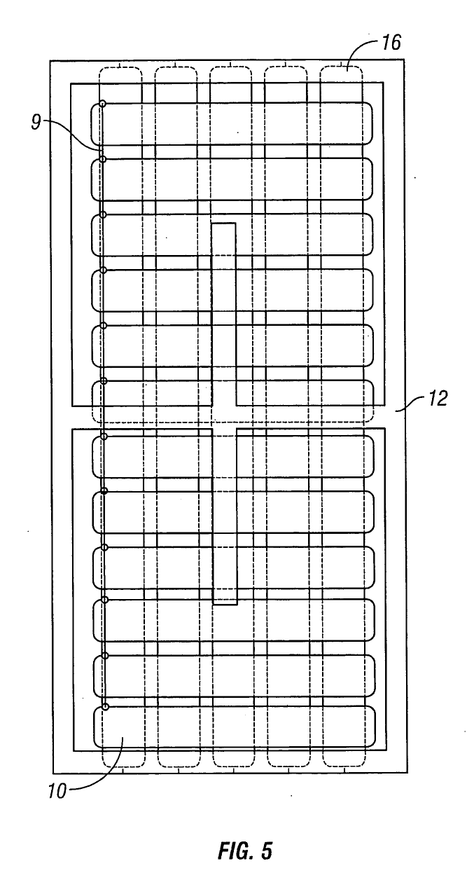

FIG. 5 shows a rear view, with some components removed for clarity, illustrating placement of first louver slats 10 and second louver slats 16 relative to frame 12 of the air driven register. In the depicted embodiment, frame 12 provides structural support or guidance for turbine shaft 2, 2′ and spur gear shaft 5 and second external spur gear shaft 13 (as illustrated in FIG. 2 and FIG. 4). In a presently preferred embodiment, a plurality of first louver slats 10 are aligned side-by-side across the airway passage area and placed beneath frame 12.

In the example embodiment depicted in FIG. 5, first louver slats 10 are each approximately one inch in width and of length to approximately fit the narrower length dimension of the air driven register. Gang bar 9 connects the plurality of first louver slats 10 such that positioning of one louver slat 10 in turn positions the remaining connected louver slats. A plurality of second louver slats 16 are placed beneath frame 12 and beneath first louver slats 10. Second louver slats 16 are each approximately one inch in width, and of a length sufficient to approximately fit the longer length dimension of the air driven register, thereby resulting in placement of second louver slats 16 approximately perpendicular to first louver slats 10. In an alternate embodiment, the orientation of first louver slats 10 and second louver slats 16 may be reversed in that the length of first louver slats 10 may approximately fit the longer length dimension of the air driven register and the length of second louver slats 16 may approximately fit the narrower length dimension of the air driven register.

In still further embodiments, second louver pivots 18 (illustrated in FIG. 1) protrude from the ends of second louver slats 16, thereby enabling pivotal connection to vent housing 15 (illustrated in FIG. 1). Second louver slats 16 each individually pivot on vent housing 15 (illustrated in FIG. 1), thereby enabling an operator to adjust second louver slats 16 to a desired pattern of airflow distribution. Alternatively, positioning of second louver slats 16 may be fixed to a desired pattern, which may be integrated into faceplate 14.

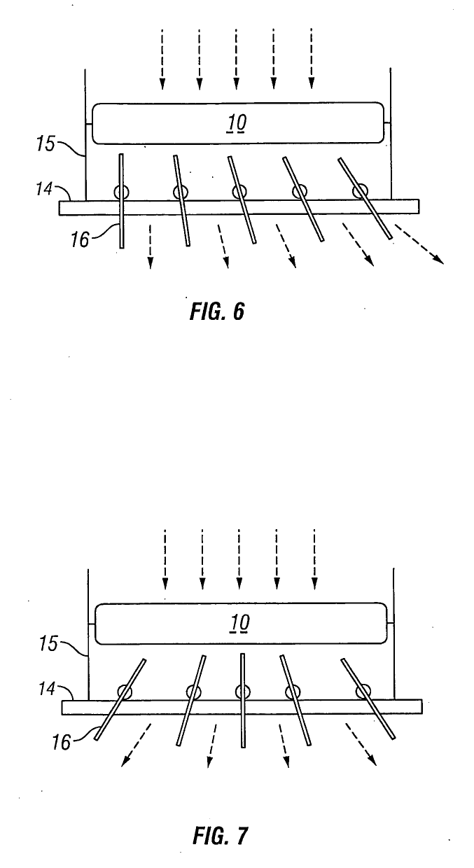

In the example embodiment of FIG. 6, a side view is provided, illustrating an asymmetric positioning of second louver slats 16 and a resulting airflow diversion. Airflow, as indicated by dashed arrows, is directed in one orthogonal direction by the position of first louver slats 10. First louver slats 10 are held in position by pivotal attachment to vent housing 15 (as also illustrated in FIG. 1). Second louver slats 16, also pivotally attached to vent housing 15 (as also illustrated in FIG. 1), are oriented beneath and approximately perpendicular to first louver slats 10. Second louver slats 16 may preferably be placed such that portions of second louver slats 16 project outward from faceplate 14. The airflow passes from first louver slats 10 and is further directed or diverted by second louver slats 16 as the airflow exits past faceplate 14 of the air driven register.

Asymmetric positioning of second louver slats 16, as illustrated in FIG. 6, is achieved by positioning second louver slats 16 on one side of the air driven register approximately parallel to the airflow received from first louver slats 10, then progressively positioning the remaining second louver slats 16 at increasing angles to the airflow received from first louver slats 10, with the second louver slats 16 on the opposite side of the air driven register positioned at approximately maximum angle to the airflow received from first louver slats 10. The asymmetric positioning of second louver slats 16 results in airflow diversion generally to one side of the air driven register. Asymmetric positioning of second louver slats 16 may be useful in placement of an air driven register near a wall of a room, where it is desired to direct airflow from the register generally in a direction away from the wall and towards the interior of the room. Alternatively, the asymmetric positioning of second louver slats 16 may be fixed to a desired pattern, which may be integrated into faceplate 14.

FIG. 7 shows a side view illustrating a symmetric positioning of second louver slats 16 and a resulting airflow diversion. Airflow, as indicated by dashed arrows, is directed in one orthogonal direction by the position of first louver slats 10. First louver slats 10 are held in position by pivotal attachment to vent housing 15 (as also illustrated in FIG. 1). Second louver slats 16, also pivotally attached to vent housing 15 (as also illustrated in FIG. 1), are oriented beneath and approximately perpendicular to first louver slats 10. Second louver slats 16 may preferably be placed such that portions of second louver slats 16 project outward from faceplate 14. The airflow passes from first louver slats 10 and is further directed or diverted by second louver slats 16 as the airflow exits past faceplate 14 of the air driven register.

Symmetric positioning of second louver slats 16, as illustrated in FIG. 7, is achieved by positioning those second louver slats 16 which are approximately in the middle of the air driven register approximately parallel to the airflow received from first louver slats 10, then progressively positioning the remaining second louver slats 16 at increasing angles to the airflow received from first louver slats 10, with the second louver slats 16 on ends of the air driven register positioned at approximately maximum angle to the airflow received from first louver slats 10. The symmetric positioning of second louver slats 16 results in airflow diversion generally outward from the sides of the air driven register. Symmetric positioning of second louver slats 16 may be useful in placement of an air driven register in the middle of a room, where it is desired to direct airflow both in the vicinity of the register and also generally in directions laterally away from the air driven register. Alternatively, the symmetric positioning of second louver slats 16 may be fixed to the desired pattern, which may be integrated into faceplate 14.

In a representative application of the invention, the air driven register of is installed in place of a typical home register and used for room air distribution.

In operation, fluid flow or airflow passes through one or more turbines 1, 1′, imparting rotational mechanical energy to turbines 1, 1′. Under common forced air systems in the United States, turbines 1, 1′ typically rotate at approximately five hundred rotations per minute. However, the actual rotations per minute in a given installation may vary considerably from this nominal value. Baffle 11 may optionally be used to further direct or concentrate airflow through turbines 1,1′. Turbines 1, 1′ in turn rotate first pinion gear 3, 3′. Pinion gear 3, 3′ imparts rotational energy to first external spur gear 4. The gear ratio between first external spur gear 4 and first pinion gear 3, 3′ is between approximately 5:1 and approximately 10:1. Using five hundred rotations per minute for turbine 1, 1′ as a basis, the original rotation of approximately five hundred rotations per minute imparts a rotation to first external spur gear 4 of approximately fifty (50) rotations per minute to approximately one hundred (100) rotations per minute. First external spur gear 4 in turn rotates second pinion gear 6. Second pinion gear 6 imparts rotational energy to second external spur gear 7. The gear ratio between second external spur gear 7 and second pinion gear 6 is between approximately 5:1 and approximately 10:1. Using basis rotation of approximately fifty (50) rotations per minute to approximately one hundred (100) rotations per minute for rotation of second pinion gear 6, the original rotation of approximately five hundred rotations per minute imparts a rotation to second external spur gear 7 of approximately five (5) to approximately twenty (20) rotations per minute.

Second external spur gear 7 imparts a reciprocating motion to lever 8, which, in turn, imparts a reciprocating motion to at least one of a plurality of first louver slats 10. First louver slats 10 each pivot on respective first louver pivots 17. Gang bar 9 acts to move a plurality of first louver slats 10 in unison, thereby resulting in oscillation of first louver slats 10 due to the reciprocating action of lever 8. The resulting oscillation of first louver slats 10 has a period of three to twelve seconds, which is approximately five (5) to approximately twenty (20) oscillations per minute, depending on choice of gear ratio and rotational speed of turbine 1, 1′. The resulting oscillation back and forth of first louver slats 10 moves air within a room, thereby breaking up temperature cells and more evenly spreading the cells around the room. Second louver slats 16 may be symmetrically, asymmetrically, or arbitrarily positioned to impart additional airflow diversion that is approximately perpendicular to the airflow diversion created by first louver slats 10. Second louver slats 16 serve to further spread temperature cells around the room.

In a presently preferred embodiment, adequate conversion of rotational speed to torque is provided by having a distance from the axial center of first pinion gear 3, 3′ to the axial center of second pinion gear 6 in a ratio to the maximal distance from the dedendum circle of the upper planar side of first external spur gear 4 to the dedendum circle of the under planar side of second external spur gear 7 of between approximately 1 to 2 and approximately 1 to 4.

Although the description above contains many specifications, these should not be construed as limiting the scope of the invention but as merely providing illustrations of some of the presently preferred embodiments of this present invention. Persons skilled in the art will understand that the method and apparatus described herein may be practiced, including but not limited to, by the embodiments described. Further, it should be understood that the invention is not to be unduly limited to the foregoing which has been set forth for illustrative purposes. Various modifications and alternatives will be apparent to those skilled in the art without departing from the true scope of the invention, as defined in the following claims. While there has been illustrated and described particular embodiments of the present invention, it will be appreciated that numerous changes and modifications will occur to those skilled in the art, and it is intended in the appended claims to cover those changes and modifications which fall within the true spirit and scope of the present invention.

1. An air distribution device comprising:
an air propelled turbine;
a first pinion gear axially connected to said turbine;
a first external spur gear in mesh connection to said first pinion gear;
a second pinion gear axially connected to said first external spur gear;
a second external spur gear in mesh connection with said second pinion gear;
a first end of a reciprocating lever in eccentric connection to said second external spur gear; and
a second end of said reciprocating lever in connection with a first plurality of louvers, said louvers in gang connection.

2. The air distribution device of claim 1 wherein said first and said second external spur gears are oriented approximately perpendicular to the flow of air.

3. The air distribution device of claim 1 wherein the distance from the axial center of said first pinion gear to the axial center of said second pinion gear has a ratio relative to the maximal distance from the dedendum circle of the upper planar side of said first external spur gear to the dedendum circle of the under planar side of said second external spur gear of between approximately 1:2 and approximately 1:4.

4. The air distribution device of claim 1 further comprising:
a second air propelled turbine; and
a second first pinion gear axially connected to said second turbine, said second first pinion gear in mesh connection to said first external spur gear.

5. The air distribution device of claim 1 further comprising a second plurality of louvers, said second plurality of louvers approximately perpendicular to said first plurality of louvers.

6. The air distribution device of claim 5 wherein positioning of said second plurality of louvers is fixed.

7. The air distribution device of claim 5 wherein each of said second plurality of louvers pivots independently.

8. The air distribution device of claim 1 wherein the gear ratio between said first external spur gear and said first pinion gear is between approximately 5:1 and approximately 10:1.

9. The air distribution device of claim 1 wherein the gear ratio between said second external spur gear and said second pinion gear is between approximately 5:1 and approximately 10:1.

10. The air distribution device of claim 1 wherein the overall gear ratio between said second external spur gear and said first pinion gear is between approximately 25:1 and approximately 100:1.

11. The air distribution device of claim 1 wherein the period of reciprocation of said first plurality of louvers is between approximately three seconds and approximately twelve seconds.

12. The air distribution device of claim 1, further comprising a baffle positioned to guide airflow through said air propelled turbine.

13. The air distribution device of claim 1, wherein said first and said second external spur gears further comprise a plurality of openings, thereby allowing air to pass through said first and said external spur gears relatively unobstructed.

14. The air distribution device of claim 1 used for room air distribution.

15. An air distribution device comprising:
an air propelled turbine;
a power transfer means in rotational connection to said air propelled turbine, whereby the rotational speed from said turbine is reduced, providing an output having a lower speed and increased torque;
a first end of a reciprocating linking means in eccentric connection to said output of said power transfer means; and
a second end of said reciprocating linking means in connection with a plurality of louvers, said louvers in gang connection.

16. The air distribution device of claim 15 wherein said power transfer means is oriented generally perpendicular to the flow of air.

17. The air distribution device of claim 15 further comprising a second air-propelled turbine in rotational connection to said power transfer means.

18. The air distribution device of claim 15 further comprising a second plurality of louvers, said second plurality of louvers approximately perpendicular to said first plurality of louvers.

19. The air distribution device of claim 18 wherein positioning of said second plurality of louvers is fixed.

20. The air distribution device of claim 18 wherein each of said second plurality of louvers pivots independently.

21. The air distribution device of claim 15 wherein said output from said power transfer means is reduced from the speed of said turbine by a ratio of between approximately 25:1 and approximately 100:1.

22. The air distribution device of claim 15 wherein the period of reciprocation of said first plurality of louvers is between approximately three seconds and approximately twelve seconds.

23. The air distribution device of claim 15 further comprising a baffle means positioned to guide airflow through said air-propelled turbine.

24. The air distribution device of claim 15 wherein said power transfer means further comprises openings, thereby allowing air to pass through said power transfer means to said plurality of louvers relatively unobstructed.

25. The air distribution device of claim 15 used for room air distribution.

26. An air distribution device comprising:
an air propelled turbine;
a first pinion gear axially connected to said turbine;
a first external spur gear in mesh connection with said first pinion gear, said first external spur gear further comprising at least one opening at least partially within the dedendum circle of said first external spur gear, thereby allowing air to pass through said first external spur gear relatively unobstructed;
a second pinion gear axially connected to said first external spur gear;
a second external spur gear in mesh connection with said second pinion gear, said second external spur gear further comprising at least one opening at least partially within the dedendum circle of said second external spur gear, thereby allowing air to pass through said second external spur gear relatively unobstructed;
a first end of a reciprocating lever in eccentric connection to said second external spur gear; and
a second end of said reciprocating lever in connection with a plurality of louvers, said louvers in gang connection.

27. The air distribution device of claim 26 wherein said first and said second external spur gears are oriented generally perpendicular to the flow of air.

28. The air distribution device of claim 26 wherein the distance from the axial center of said first pinion gear to the axial center of said second pinion gear has a ratio to the maximal distance from the dedendum circle of the upper planar side of said first external spur gear to the dedendum circle of the under planar side of said second external spur gear of between approximately 1 to 2 and approximately 1 to 4.

29. The air distribution device of claim 26 further comprising:
a second air propelled turbine; and
a second first pinion gear axially connected to said second turbine, said second first pinion gear in mesh connection to said first external spur gear.

30. The air distribution device of claim 26 further comprising a second plurality of louvers, said second plurality of louvers approximately perpendicular to said first plurality of louvers.

31. The air distribution device of claim 30 wherein positioning of said second plurality of louvers is fixed.

32. The air distribution device of claim 30 wherein each of said second plurality of louvers pivots independently.

33. The air distribution device of claim 26 wherein the gear ratio between said first external spur gear and said first pinion gear is between approximately 5:1 and approximately 10:1.

34. The air distribution device of claim 26 wherein the gear ratio between said second external spur gear and said second pinion gear is between approximately 5:1 and approximately 10:1.

35. The air distribution device of claim 26 wherein the overall gear ratio between said second external spur gear and said first pinion gear is between approximately 25:1 and approximately 100:1.

36. The air distribution device of claim 26 wherein the period of reciprocation of said first plurality of louvers is between approximately three seconds and approximately twelve seconds.

37. The air distribution device of claim 26 further comprising a baffle positioned to guide airflow through said air propelled turbine.

38. The air distribution device of claim 26 used for room air distribution.
